(19) United States
(12) Patent Application Publication
(10) Pub. No.: US 2023/0065744 A1
(43) Pub. Date: Mar. 2, 2023

(54) GRAPHICAL USER INTERFACE FOR ABATING EMISSIONS OF GASEOUS BYPRODUCTS FROM HYDROCARBON ASSETS

(71) Applicant: Halliburton Energy Services, Inc., Houston, TX (US)

(72) Inventors: Thomas Cousins, London (GB); Leopoldo Sayavedra, JR., Houston, TX (US); Smitha Hariharan, Tomball, TX (US); Neil Wands, Walton on Thames (GB)

(21) Appl. No.: 17/446,098

(22) Filed: Aug. 26, 2021

(51) Int. Cl. E21B 43/12; E21B 47/008; B64C 39/02

(52) U.S. Cl. CPC E21B 43/13; B64C 39/024; E21B 47/008; B64C 2201/12; E21B 2200/20

(57) ABSTRACT

Graphical user interfaces for abating emissions of gaseous byproducts at hydrocarbon assets are described herein. In one example, a system can receive measurements of gaseous byproduct emissions from sites. The system can execute a classification module to distribute the measurements among various types of equipment. The system can then determine emissions estimates associated with the various types of equipment based on the measurements assigned to each type of equipment. Thereafter, the system can receive a user input that includes a list of types of equipment at a target site. The system can generate a total emissions estimate for each type of equipment in the list based on the emissions estimates. The system can then generate a graphical user interface providing the total emissions estimate for each type of equipment in the list to a user, which may help the user abate such emissions.

### TECHNICAL FIELD

The present disclosure relates generally to gas emissions from hydrocarbon assets. More specifically, but not by way of limitation, this disclosure relates to a graphical user interface for assisting operators in abating emissions of gaseous byproducts from one or more hydrocarbon assets associated with producing and processing hydrocarbons from a subterranean formation.

### BACKGROUND

A hydrocarbon asset can include one or more sites. A site is a location associated with producing and processing hydrocarbons. Examples of such sites can include wellsites, refinement sites, production sites, etc. Each site can include one or more hydrocarbon facilities with equipment used to produce hydrocarbons, bring them to the surface, store them, process them, and/or prepare them for export to market. Examples of this equipment can include well heads, flow lines, tanks, separators, trunk lines, etc. During the hydrocarbon production operations, the equipment can emit various gaseous byproducts that are different from the target hydrocarbon to be produced. Examples of such gaseous byproducts can include methane, propane, and carbon dioxide. These and other gaseous byproducts may be released, for example, while extracting oil from a subterranean formation and handling/preparing it for export to market. These gaseous byproducts may include pollutants that are hazardous to the environment or to workers at the site.

### BRIEF DESCRIPTION OF THE DRAWINGS

FIG. 1 depicts an example of a system for abating emissions of gaseous byproducts according to some aspects of the present disclosure.

FIG. 2 depicts another example of a system for abating emissions of gaseous byproducts according to some aspects of the present disclosure.

FIG. 3 depicts an example of information stored in a datastore according to some aspects of the present disclosure.

FIG. 4 depicts a flow chart of an example of a process for generating a graphical user interface according to some aspects of the present disclosure.

FIG. 5 depicts an example of a graphical user interface according to some aspects of the present disclosure.

FIG. 6 depicts an example of a graphical user interface according to some aspects of the present disclosure.

FIG. 7 depicts an example of a graphical user interface according to some aspects of the present disclosure.

### DETAILED DESCRIPTION

Certain aspects and features of the present disclosure relate to a graphical user interface (GUI) system for assisting operators (e.g., oil and gas operators) in abating emissions of gaseous byproducts at their hydrocarbon facilities. The gaseous byproducts may be unwanted emissions of gaseous pollutants. The GUI system can allow a user to upload data collected from a variety of detection data sources, such as satellites, airplanes, airborne drones, and ground-level sensors. The data can include measurements quantifying the amount of a gaseous byproduct released at one or more sites. The GUI system can then execute a classification module to determine how to assign the measurements to different types of equipment at the one or more sites. For example, the classification module can classify each measurement in the data as belonging to a particular type of equipment at a specific site. With the measurements assigned, the GUI system can generate an emissions estimate for each of the different types of equipment at the one or more sites. An emissions estimate is an estimate of how much of the gaseous byproduct is output by a particular type of equipment during a particular timespan.

Having determined the emissions estimates, the GUI system can next use the emissions estimates to determine how much of the gaseous byproduct is emitted in total by each type of equipment at a target site or a target asset, which can be selected by the user. For example, the user can input one or more types of equipment present at the target site. Based on the emissions estimates, the GUI system can determine and output values indicating how much of the gaseous byproduct is emitted in total by each type of equipment. In some examples, the values can be predictions indicating how much of the gaseous byproduct will be emitted by each type of equipment in total during a future timespan. These values can allow an operator to gain greater insight into how the gaseous byproduct was or will be emitted at the target site, so that the operator can take preemptive steps or remedial steps to abate such emissions.

In some examples, the collected data can include site-level measurements. Site-level measurements are higher-level measurements characterizing gaseous byproduct emissions at a specific site as a whole, rather than at the equipment level. The site-level measurements may be generated by higher-level sensing equipment, such as satellites, airborne drones, and airplanes. Additionally or alternatively, the collected data can include equipment-level measurements. Equipment-level measurements are lower-level measurements characterizing gaseous byproduct emissions by individual types of equipment within a specific site, rather than at the site as a whole. The equipment-level measurements may be generated by lower-level sensing equipment, such as ground-level sensors positioned proximate to the equipment at a site. Equipment-level measurements may be easier to assign to the different types of equipment than site-level measurements. Thus, the GUI system can include the classification module to aid in dividing a site-level measurement into subcomponents that are attributable to different types of equipment.

To effectuate this classification functionality, the classification module may include a classification model. The classification model may be a machinelearning model capable of learning and improving in accuracy over time. In some examples, the classification module can include a linear optimization model having an objective function and constraints, some or all of which may be updated over time. The classification module can “learn” and become “smarter” as it is exposed to more data over time, so that the classification module can accurately assign collected measurements to different types of equipment. This, in turn, can lead to more accurate emissions estimates. In some examples, operational data can also be used to improve the model’s accuracy over time. Examples of such operational data can include pressure readings and leak detection and repair (LDAR) reports.

In some examples, the GUI system is capable of determining the emissions estimates using two different techniques (e.g., two different algorithms). One of the techniques may be selected as a preferred technique over the other technique. In some examples, the GUI system can determine whether a given type of site equipment (e.g., a particular type of well equipment) has a sufficient number of measurements assigned thereto to generate an accurate emissions estimate using the preferred technique. For example, the GUI system can compare the number of measurements assigned to a particular type of equipment to a predefined threshold value to determine whether the number of measurements meets or exceeds the threshold value. The threshold value may be a selected to give a desired level of confidence in the estimation. If the number of measurements does not meet or exceed the threshold value, it may mean that there is an insufficient number of measurements assigned to the particular type of equipment to generate an accurate emissions estimate using the preferred technique. So, the GUI system can notify the user that more measurements are required to generate an accurate emissions estimate using the preferred technique. Additionally or alternatively, the GUI system can determine an emissions estimate using the other technique and provide that emissions estimate to the user in the GUI. In this way, the GUI system can fall back to the other technique if there is an insufficient amount of data to compute the emissions estimates using the preferred technique.

In some examples, the GUI system can integrate a variety of data sources and machine learning together to help operators better understand how gaseous byproducts are emitted at their hydrocarbon facilities. This approach can be faster, more cost effective, and require less sensing equipment than other approaches, such as monitoring their sites on a relatively continuous basis with satellites, drones, and ground sensors. This approach can also be more accurate, data driven, and operator specific than relying on industry-standard emissions estimates, such as precomputed emissions factors for equipment (e.g., oil and gas equipment) published by the American Petroleum Institute® or the Environmental Protection Agency®. In other words, the GUI system can provide operators with a hybrid approach that may allow them to deploy fewer resources and spend less time on monitoring and detection, while obtaining a more accurate picture of the gaseous-byproduct emissions footprint across their asset portfolio. With a better understanding of this footprint, operators can set more-realistic reduction targets (e.g., methane reduction targets) with respect to gaseous byproduct emissions. And by better understanding how the different equipment contributes to this footprint, operators can implement more effective abatement techniques to reduce their footprint and meet those reduction targets.

In some examples, the GUI system can also enable operators to monitor for potential problem assets. For example, the GUI can include alerting functionality for outputting alerts. The GUI system can output the alerts, for example, if certain types of equipment or certain hydrocarbon facilities emit an amount of a gaseous byproduct that meets or exceeds an alerting threshold. The alerts and alert thresholds may be selectable and customizable by the user. These and other aspects of the GUI system may allow operators to prevent catastrophes (e.g., if there is a leak of a volatile byproduct gas that could lead to an explosion or hazardous conditions), as well as more easily track and meet their reduction targets.

These illustrative examples are provided to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

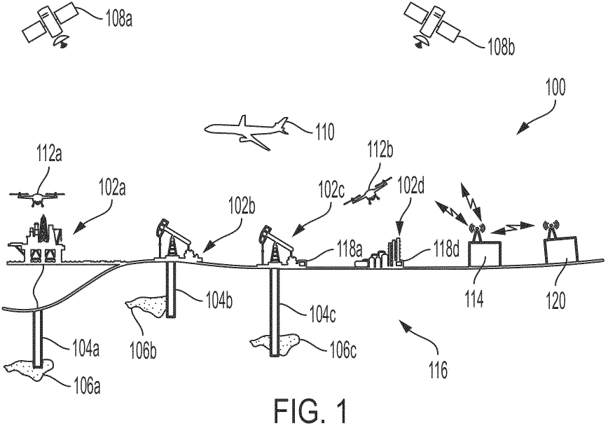

FIG. 1 depicts an example of a system 100 for abating emissions of gaseous byproducts from one or more sites 102a-d according to some aspects of the present disclosure. Some of the sites 102a-c can include wellbores 104a-c drilled through a subterranean formation 116. The wellbores 104a-c can be cased or uncased. The wellbores 104a-c may be drilled proximate to hydrocarbon reservoirs 106a-c for extracting the hydrocarbons therein from the subterranean formation 116. The sites 102a-d can include different types of equipment for performing various operations, such as drilling, processing, and production operations. Examples of the different types of equipment can include well heads, flow lines, tanks, separators, trunk lines, etc. As a result of various operations, the sites 102a-d may emit a gaseous byproduct. Examples of such gaseous byproducts can include methane, propane, and carbon dioxide. The gaseous byproduct may be emitted into the atmosphere or the surrounding environment. It may be desirable to monitor and control these emissions.

To help monitor emissions of the gaseous byproduct, the system 100 may include mobile sensing equipment, such as satellites 108a-b, airborne drones 112a-b, airplanes 110, and robots. The mobile sensing equipment can collect data about how much of a gaseous byproduct is released at the sites 102a-d. Rather than being relatively fixed in static locations at the sites 102a-d, the mobile sensing equipment is movable to collect the data. For example, the mobile sensing equipment can fly over or pass through the sites 102a-d to collect the data. During operation, the mobile sensing equipment may be spaceborne, airborne, or otherwise physically distant from the sites 112a-d they are monitoring.

The mobile sensing equipment can include sensors for collecting images or other data about how much of a gaseous byproduct is released at the sites 102a-d. Examples of the sensors can include gas sensors, thermal sensors, cameras or other imaging devices (e.g., infrared imaging devices), etc. The mobile sensing equipment can collect the data and may convert the data into corresponding measurements. The mobile sensing equipment can then transmit the measurements to one or more data acquisition systems 114. The measurements can be transmitted via one or more networks, such as satellite networks and the Internet. Such measurements may be normalized (e.g., standardized) before or after transmission.

The system 100 can also include fixed sensing equipment 118a-b positioned at the sites 102a-d. The fixed sensing equipment can collect data about how much of the gaseous byproduct is released at the sites 102a-d. Rather than being movable over or through the sites 102a-d, the fixed sensing equipment 118a-b is relatively fixed in static locations at the sites 102a-d. Like the mobile sensing equipment, the fixed sensing equipment can include sensors for collecting images or other data about how much of a gaseous byproduct is released at the sites 102a-d. Examples of such sensors can include gas sensors, thermal sensors, cameras or other imaging devices (e.g., infrared imaging devices), etc. The fixed sensing equipment can collect the data and may convert the data into corresponding measurements. The fixed sensing equipment can then transmit the measurements to one or more data acquisition systems 114. The measurements can be transmitted via one or more networks, such as satellite networks and the Internet. Such measurements may be normalized before or after transmission.

The data acquisition systems 114 can receive the measurements from the mobile sensing equipment and the fixed sensing equipment 118a-b. Additionally or alternatively, the data acquisition systems 114 can receive measurements of gaseous byproduct emissions from other data sources. The data acquisition systems 114 can receive, process, and store the measurements for subsequent use.

While it may be desirable to monitor emissions of the gaseous byproduct at a target site on a relatively continuous basis, deploying all of these different types of sensing equipment on a relatively frequent basis to do so can be inefficient, expensive, and time consuming. To help reduce these burdens while still providing accurate monitoring and detection, some examples of the present disclosure include a computing system 120 capable of implementing advanced analysis techniques to generate a GUI designed to help an operator monitor and abate emissions of the gaseous byproduct at a target site. The target site may be one of the sites 102a-d from which the measurements were collected or may be another site.

More specifically, the computing system 120 can receive measurements collected from the sensing equipment over a period of time. The computing system 120 may receive the measurements directly from or indirectly from (e.g., via the data acquisition systems 114) the sensing equipment. The computing system 120 can then process the measurements to create a historical dataset. Processing the measurements can include normalizing and removing outliers from the measurements. Normalizing the measurements can involve standardizing their metrics, units, frequencies, or any combination of these. The computing system 120 can then apply machine learning or other analysis techniques to the historical dataset to generate emissions estimates at the equipment level. For example, the computing system 120 can determine an emissions estimate for each individual type of equipment, where the emissions estimate for a given type of equipment is an estimate of gaseous byproduct emissions by that type of equipment during a particular time interval. Based on how many pieces of each type of equipment are located at the target site, the computing system 120 can compute the expected total emissions output from each individual type of equipment at the target site during a selected time interval. This information can then be provided to an operator in a GUI, which can also provide additional insights into gaseous byproduct emissions at the target site.

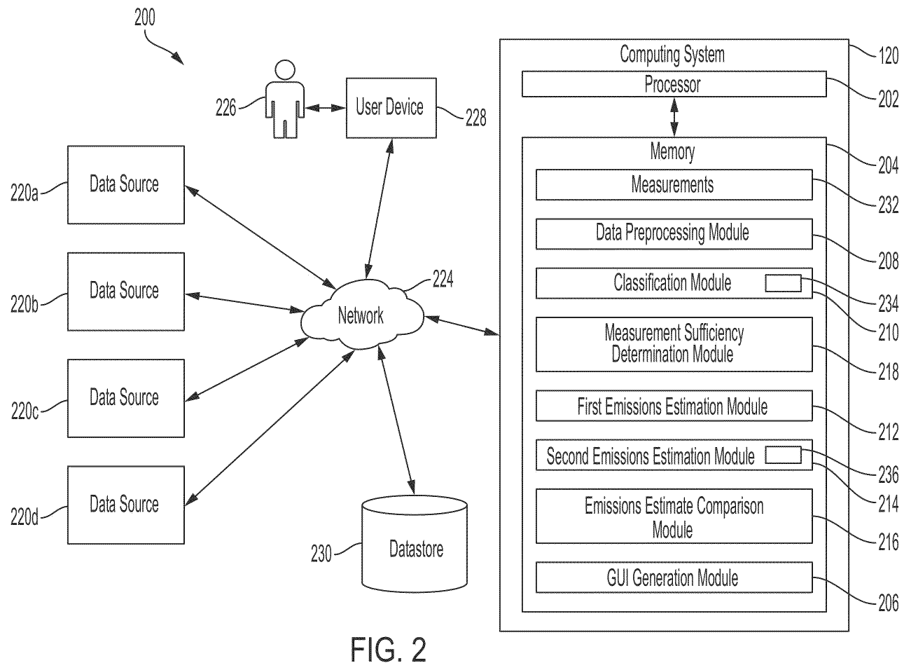

One example of the computing system 120 is shown in FIG. 2, along with other components of a system 200 for generating a GUI usable to abate emissions of gaseous byproducts at one or more hydrocarbon facilities according to some aspects of the present disclosure. Examples of the computing system 120 can include one or more desktop computers, laptop computers, servers, etc. The computing system 120 may be part of a cloud computing environment or a computing cluster, in some examples.

The computing system 120 can receive measurements 232 of gaseous byproduct emissions associated with one or more monitored sites over one or more networks 224, such as satellite networks, wide area networks, local area networks, or the Internet. In some examples, the computing system 120 can receive the measurements 232 from a user device 228. The user device 228 can be, for example, a desktop computer, a laptop computer, or a mobile device. A user 226 can operate the user device 228 to provide (e.g., input or upload) the measurements 232 to the computing system 120. In other examples, the computing system 120 can receive the measurements 232 from a datastore 230. The datastore 230 may be associated with the data acquisition system of FIG. 1. For example, the data acquisition system can store the measurements 232 in the datastore 230, which can subsequently be accessed by the computing system 120 to obtain the measurements 232.

The measurements 232 may be generated by one or more data sources 220a-d, which may include any of the sensing equipment described above. For example, data source 220a may be a satellite, data source 220b may be an unmanned aircraft such as a drone, data source 220c may be a manned aircraft, and data source 220d may be fixed sensing equipment such as a gas sensor. Of course, any number and combination of mobile sensing equipment and fixed sensing equipment may generate the measurements 232 for use by the computing system 120. In some examples, operational data about equipment operation may be used in addition to, or as an alternative to, measurements from the fixed sensing equipment.

The computing system 120 can include a processor 202 communicatively coupled to a memory 204. The processor 202 is hardware that can include one processing device or multiple processing devices. Non-limiting examples of the processor 202 include a Field-Programmable Gate Array (FPGA), an application-specific integrated circuit (ASIC), or a microprocessor. The processor 202 can execute instructions (e.g., software modules 206-218) stored in the memory 204 to perform computing operations. The instructions may include processor-specific instructions generated by a compiler or an interpreter from code written in any suitable computer-programming language, such as C, C++, C#, Python, or Java.

The memory 204 can include one memory device or multiple memory devices. The memory 204 can be volatile or can be non-volatile such that it can retain stored information when powered off. Some examples of the memory 204 can include electrically erasable and programmable read-only memory (EEPROM), flash memory, or any other type of non-volatile memory. At least some of the memory 204 includes a non-transitory computer-readable medium from which the processor 202 can read instructions. A computer-readable medium can include electronic, optical, magnetic, or other storage devices capable of providing the processor 202 with computer-readable instructions or other program code. Some examples of a computer-readable medium include magnetic disks, memory chips, ROM, random-access memory (RAM), an ASIC, a configured processor, optical storage, or any other medium from which a computer processor can read the instructions.

In some examples, the memory 204 includes a group of software modules 206-218 for implementing some aspects of the present disclosure. Although the software modules 206-218 are shown in FIG. 2 as being separate from one another, this is for illustrative purposes and not intended to be limiting. In other examples, the functionality of two or more of the software modules 206-218 may be combined together into a single software module. Similarly, the functionality of any single software module may be divided up into multiple software modules. Each of these software modules 206-218 will now be described in turn below.

As shown in FIG. 2, the computing system 120 can include a data preprocessing module 208. The data preprocessing module 208 is executable to access the measurements 232 and apply one or more preprocessing techniques to the measurements 232. One example of such preprocessing techniques can include normalizing or otherwise standardizing the measurements 232. For example, the data preprocessing module 208 can normalize the measurements 232 so that they all have the same units, such as parts per million (ppm) or standard cubic feet per hour (scf/h). This may involve converting measurements from one type of unit to another type of unit using one or more predefined algorithms. Another example of the preprocessing techniques can include removing outliers from the measurements 232. For example, the data preprocessing module 208 can delete or otherwise remove measurements that fall outside of a predefined range of measurement values (e.g., an expected range of measurement values). Applying the preprocessing techniques can improve the accuracy of subsequent processes performed using the measurements 232. With the preprocessing complete, the data preprocessing module 208 can transmit the preprocessed measurements to the classification module 210.

The classification module 210 can receive the measurements 232 (e.g., the preprocessed measurements) and classify each measurement in the data as belonging to a particular type of equipment. The measurements 232 can include higher-level measurements and lower-level measurements. An example of a higher-level measurement can be a site-level measurement. A site-measurement is a moreholistic measurement of the total amount of a gaseous byproduct emitted at a specific site as a whole, for example from multiple pieces of equipment (e.g., well equipment or production equipment) at the site. Such site-level measurements may be obtained by using mobile sensing equipment like a satellite, drone, or airplane. An example of a lower-level measurement can be an equipment-level measurement. An equipment-level measurement is a measurement of gaseous byproduct emissions from an individual piece of equipment. Such equipment-level measurements may be obtained by using fixed sensing equipment like gas sensors and thermal sensors at the site.

To assist in classifying the measurements 232, the classification module 210 can include a classification model 234. In some examples, the classification model 234 can include a linear optimization model having an objective function and one or more constraints. In other examples, the classification model 234 can include a neural network, Naive Bayes classifier, decision tree, logistic regression classifier, a support vector machine, or any combination of these. The classification module 210 can use the classification model 234 to automatically analyze the measurements 232 and determine how to classify each measurement. For example, if a measurement is a lower-level measurement like an equipment-level measurement, the classification model 234 may be able to easily assign the measurement to its corresponding type of equipment. If the measurement is a higher-level measurement like a site-level measurement, the classification model 234 may divide the measurement into subcomponents and assign each subcomponent to a different type of equipment. For example, the classification model 234 can divide a site-level measurement of 270 SCF/hr/day into three subcomponents of 100 SCF/hr/day, 150 SCF/hr/day, and 20 SCF/hr/day. The classification model 234 can then assign each of the three subcomponents to a corresponding type of equipment, for example such that 100 SCF/hr/day is assigned to a tank, 150 SCF/hr/day is assigned to a separator, and 20 SCF/hr/day is assigned to a valve.

The classification model 234 can learn how to divide a higher-level measurement among different types of equipment based on its exposure to training data. For example, the classification model 234 can be trained using the training data. The training data can include relationships between higher-level measurements and lower-level measurements. For example, the training data can include relationships between site-level measurements and equipment-level measurements. In some examples, the higher-level measurements and equipment-level measurements may be collected from the data sources 220a-d over a period of time, and the relationships in the training data can be generated based on those measurements. For example, data source 220a may provide a site-level measurement of an amount of methane gas emitted at a specific site. Data sources 220b-d may be sensors coupled to individual pieces of equipment at the site, where the sensor can provide equipment-level measurements of the amount of methane gas emitted from each individual piece of equipment at the site. Based on these measurements, it can be determined how much methane gas each individual type of equipment contributed to the site-level measurement. The proportion with which each individual type of equipment contributed to the site-level measurement can then be stored in the training data. This process can be repeated hundreds or thousands of times, using measurements from one or multiple sites, to create the training data.

In some examples, the classification model 234 can be periodically retrained. For example, additional measurements can be collected over time from the data sources 220a-d and used to update the training data. The classification model 134 can then be retrained using the updated training data. In this way, the classification model 234 may be capable of learning and improving in accuracy over time as it is exposed to more measurements from the data sources 220a-d.

Once the measurements 232 have been assigned to their respective types of equipment, the computing system 120 can execute the measurement sufficiency determination module 218. The measurement sufficiency determination module 218 can determine whether there is a sufficient number of measurements assigned to a particular type of equipment to generate an emissions estimate for that particular type of equipment using the first emissions estimation module 212. In some examples, this can involve a straight comparison of the number of measurements assigned to a particular type of equipment to a predefined threshold value. If the number of measurements meets or exceeds the predefined threshold value, then measurement sufficiency determination module 218 can flag the particular type of equipment as having sufficient data. If the number of measurements is below the predefined threshold value, then measurement sufficiency determination module 218 can flag the particular type of equipment as having insufficient data. In other examples, a more sophisticated approach can be used. For example, the measurement sufficiency determination module 218 can determine a sample size of the measurements for a particular type of equipment. The sample size can be determined according to the following equation:

$$n = \frac{N \times X}{X + N - 1}$$

where n is the sample size, N is the population size (e.g., the total number of measurements assigned to the type of equipment), and X is computed as follows:

$$X = \frac{{z}^{2} \times p \times \left(1 - p\right)}{M O {E}^{2}}$$

where z is a calibration factor such as 1.96, MOE is an allowable margin of error, and p is a sample proportion. If the sample size (n) is meets or exceeds the predefined threshold value, then measurement sufficiency determination module 218 can flag the particular type of equipment as having sufficient data. If the sample size (n) is below the predefined threshold value, then measurement sufficiency determination module 218 can flag the particular type of equipment as having insufficient data. The measurement sufficiency determination module 218 can perform a similar process for each individual type of equipment.

The computing system 120 can next execute the first emissions estimation module 212 in relation to the types of equipment that have a sufficient number of measurements (as determined by the measurement sufficiency determination module 218). For example, if the measurement sufficiency determination module 218 determined that a sufficient number of measurements have been assigned to a particular type of tank, the computing system 120 can execute the first emissions estimation module 212 with respect to the particular type of tank.

The first emissions estimation module 212 is executable to determine a first emissions estimate for a particular type of equipment. To determine the first emissions estimate, the first emissions estimation module 212 can execute a first algorithm based on the measurements assigned to the particular type of equipment. One example of the first algorithm can be a mean algorithm, where the first emissions estimate is a mean of the measurements assigned to the particular type of equipment. The mean can be computed by dividing (i) a total value of the measurements (e.g., as determined by summing together the measurements) by (ii) the total number of measurements assigned to the particular type of equipment. But the first algorithm can be another type of algorithm in other examples. The first emissions estimation module 212 can be executed for each individual type of equipment to determine a corresponding emissions estimate.

The computing system 120 may also execute the second emissions estimation module 214. In some examples, the computing system 120 can execute the second emissions estimation module 214 only in relation to the types of equipment that have an insufficient number of measurements (as determined by the measurement sufficiency determination module 218). Thus, the second emissions estimation module 214 may be executed as a fall back in situations where there is an insufficient number of measurements to execute the first emissions estimation module 212. In other examples, the computing system 120 can execute the second emissions estimation module 214 in relation to some or all of the types of equipment, regardless of how many measurements are assigned thereto.

The second emissions estimation module 214 is executable to determine a second emissions estimate for a particular type of equipment. To determine the second emissions estimate, the second emissions estimation module 214 can execute a second algorithm based on the measurements assigned to the particular type of equipment. The second algorithm can be different from the first algorithm. Alternatively, the second emissions estimation module 214 can determine the second emissions estimate by accessing a lookup table 236. The lookup table 236 can include a mapping between (i) different types of equipment and (ii) predetermined emissions estimates for the different types of equipment. The predetermined emissions estimates can be industry-standard emissions estimates, such as precomputed emissions factors for oil and gas equipment published by the American Petroleum Institute® or the Environmental Protection Agency®.

Using the above techniques, the computing system 120 may determine both a first emissions estimate (using the first emissions estimation module 212) and a second emissions estimate (using the second emissions estimation module 214) for a particular type of equipment. It may be desirable to determine which estimate is more accurate. To that end, the computing system 120 can execute the emissions estimate comparison module 216.

The emissions estimate comparison module 216 can determine a first accuracy metric for the first emissions estimate and a second accuracy metric for the second emissions estimate. One example of such an accuracy metric can be a confidence interval. The confidence interval for an emissions estimate can be determined for an accuracy metric using the following equation:

$$C I = \overline{x} \pm z \frac{s}{\sqrt{n}}$$

where CI is the confidence interval, x is the sample mean, z is the confidence level value, s is the sample standard deviation, and n is the sample size. In some examples, the sample size n may be computed using Equation 1 above. Alternatively, the sample size n may be the total number of measurements assigned to a particular type of equipment. The emissions estimate comparison module 216 can determine the first accuracy metric for the first emissions estimate using Equation 3 or another algorithm. The emissions estimate comparison module 216 may also determine the second accuracy metric for the second emissions estimate using Equation 3 or another algorithm. Alternatively, the emissions estimate comparison module 216 may determine the second accuracy metric by accessing a lookup table, such as the lookup table 236. The lookup table can include accuracy metrics associated with the predefined emissions estimates stored in the lookup table 236. After determining the first accuracy metric and the second accuracy metric, the emissions estimate comparison module 216 can compare the first accuracy metric to the second accuracy metric to determined which of the two estimates is the most accurate.

Some or all of the above-described information can be stored by the computing system 120 in a datastore 230. The datastore 230 may be internal to the computing system 120 or accessible to the computing system 120 via a network, such as network 224. The datastore 230 may include one or more memories for storing data.

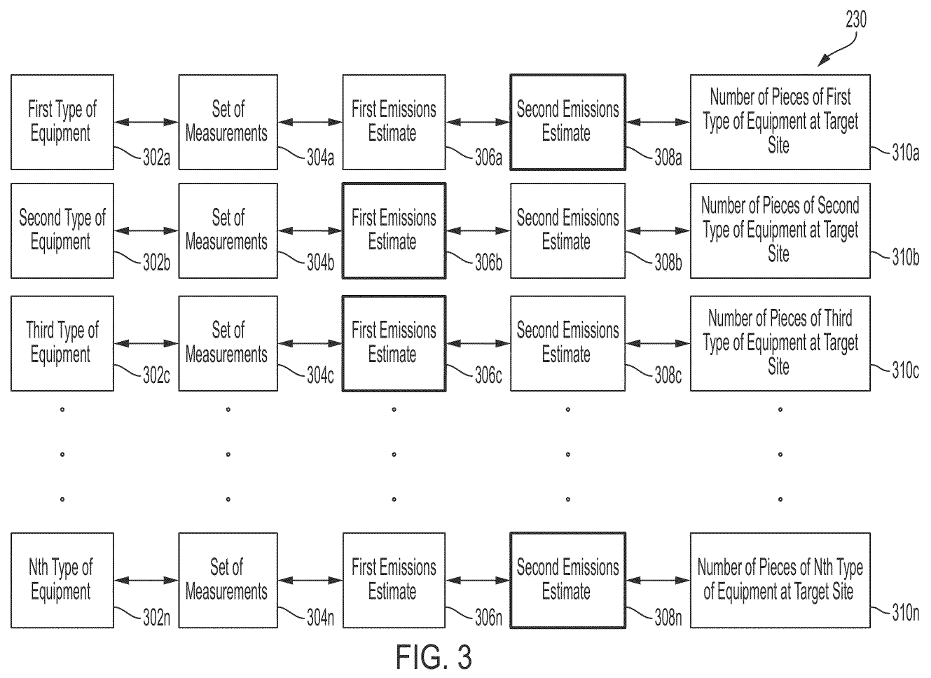

One example of the information stored in the datastore 230 is shown in FIG. 3. As shown, the datastore 230 can include different types of equipment 302a-n mapped to their respective sets of measurements 304a-n, their respective first emissions estimates 306a-n generated using the first emissions estimation module 212, and their respective second emissions estimates 308a-n generated using the second emissions estimation module 214. Whichever of the two emissions estimates is more accurate for a particular type of equipment can be flagged in the datastore 230. This is represented in FIG. 3 by a bold border around whichever of the two emissions estimates is most accurate. For example, the second emissions estimate 308a is more accurate than the first emissions estimate 306a, so the second emissions estimate 308a is depicted in FIG. 3 with a bold border. Conversely, the first emissions estimate 306b is more accurate than the second emissions estimate 308b, so the first emissions estimate 306b is depicted in FIG. 3 with a bold border. The datastore 230 can also include the number of pieces of each type of equipment 310a-n that are located at a target site. This information can be input by a user for use in determining the total amount of a gaseous byproduct emitted by each type of equipment at a target site as described in greater detail below.

Referring back to FIG. 2, the computing system 120 can execute the GUI generation module 206 to generate a GUI for display to the user 226. The user 226 can interact with the GUI via the user device 228. Through the GUI, the user 226 can input, upload, or select a dataset specifying which types of equipment are located at a target site and how many pieces of each type of equipment are located at the target site. For example, the GUI may present first visual page through which the user 226 can input, upload, or select the dataset. The dataset can include numerical values specifying how many pieces of each type of equipment are located at a target site. For example, the dataset can specify that there are 7 tanks and 3 separators at the site. Upon receipt by the computing system 120, the dataset can be stored in the datastore 230 (if it is not already present there) as shown in FIG. 3.

Next, the GUI generation module 206 can then determine the total amount of the gaseous byproduct emitted by a particular type of equipment over a selected time period. This can be referred to as a total emissions estimate. To determine the total emissions estimate for a particular type of equipment, the GUI generation module 206 can use the following equation:

$$T o t a l e m i s s i o n s e s t i m a t e = \left(E E\right) \times \left(N u m\right)$$

where EE is an emissions estimate and Num is the number of pieces of that type of equipment specified in the dataset. In some examples, the GUI generation module 206 can determine whether a first emissions estimate exists for the particular type of equipment. This determination can be made by accessing the datastore 230. If not, the GUI generation module 206 can output an alert to the user 226 indicating that more measurements are required to generate the first emissions estimate. The GUI generation module 206 may then determine the total emissions estimate using the second emissions estimate in Equation 4. If the first emissions estimate and the second emissions estimate both exist, the GUI generation module 206 can determine which of the two emissions estimates is most accurate (e.g., based on the output of the emissions estimate comparison module 216). The GUI generation module 206 can then determine the total emissions estimate by using the most-accurate emissions estimate in Equation 4. Alternatively, the GUI can determine two total emissions estimates by using Equation 4 twice, once with the first emissions estimate and once with the second emissions estimate. If only the first emissions estimate exists (the second emissions estimate does not), the GUI generation module 206 can determine the total emissions estimate by using the first emissions estimate in Equation 4. This process can be repeated to generate one or more total emissions estimates for each type of equipment in the dataset.

Having generated the total emissions estimate(s) for each type of equipment, the GUI generation module 206 can update the graphical user interface to display the total emissions estimate(s) for each type of equipment. For example, the graphical user interface can include a list of each type of equipment included in the dataset. Next to each item on the list can be one or more corresponding total emissions estimate. Graphs and charts may also be included in the graphical user interface to help the user 226 visualize how each type of equipment contributes to a total amount of gaseous byproduct emissions output at the target site. These visual elements may be interactive, for example so that the user can drill down into the specific details about gaseous emissions at the target site or explore the data at different conceptual levels, such as at the asset level.

Although a certain number and arrangement of components is shown in FIG. 2 is for illustrative purposes, this is for illustrative purposes and not intended to be limiting. Other examples may include components, fewer components, different components, or a different arrangement of the components shown in FIG. 2.

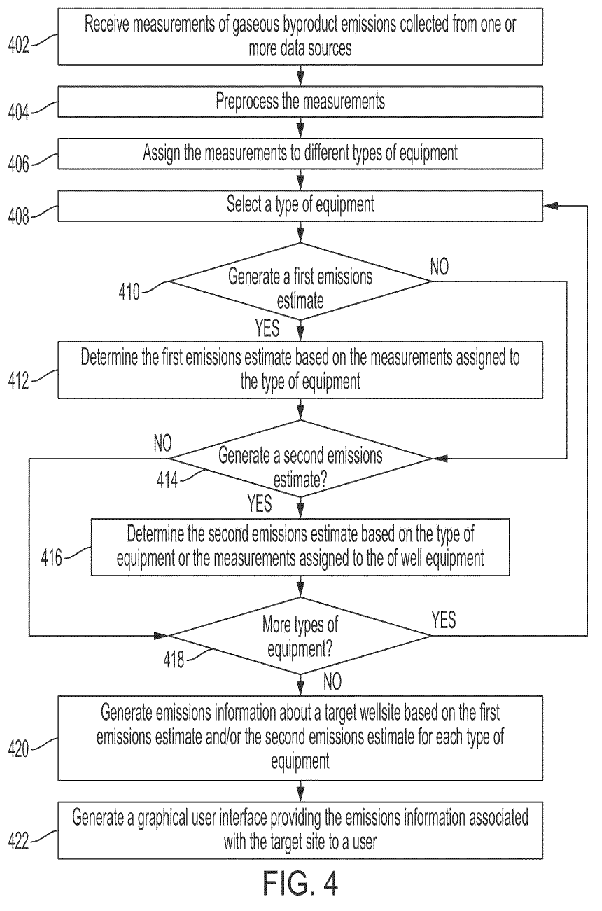

In some examples, the computing system 120 can implement the process shown in FIG. 4. For example, the computing system 120 may implement the process by executing some or all of the software modules 206-216 to perform any of the techniques described above. Of course, the precise sequence of steps shown in FIG. 4 is intended to illustrative and non-limiting. Other examples may include more steps, fewer steps, different steps, or a different order of the steps than is shown in FIG. 4. The steps of FIG. 4 will now be described below with reference to the components of FIG. 2 described above.

In block 402, the computing system 120 receives measurements 232 of gaseous byproduct emissions collected from one or more data sources 220a-d.

In block 404, the computing system 120 preprocesses the measurements 232. For example, the computing system 120 can execute the data preprocessing module 208 to perform any of the data preprocessing techniques described above.

In block 406, the computing system 120 assigns the measurements 232 to different types of equipment. For example, the computing system 120 can execute the classification module 210 to perform any of the classification techniques described above.

In block 408, the computing system 120 selects a type of equipment. The computing system 120 can select a type of equipment from among multiple types of equipment that are available for selection. For example, the computing system 120 may select a type of equipment from a predefined list of types of equipment.

In block 410, the computing system 120 determines whether a first emissions estimate is to be generated. For example, the computing system 120 can execute the measurement sufficiency determination module 218 to determine whether there is a sufficient number of measurements or samples associated with the selected type of equipment. If so, the computing system 120 can determine that a first emissions estimate is to be generated and the process can continue to block 412. Otherwise, the computing system 120 can determine that a first emissions estimate is not to be generated and the process can continue to block 414.

In block 412, the computing system 120 generates the first emissions estimate for the selected type of equipment. For example, the computing system 120 can execute the first emissions estimation module 212 to generate the first emissions estimate.

In block 414, the computing system 120 determines whether a second emissions estimate is to be generated. For example, the computing system 120 can determine whether a first emissions estimate was generated in block 410. If not, the computing system 120 may generate the second emissions estimate (e.g., as a fall back, so that there is always at least one type of emissions estimate for the selected type of equipment). If the first emissions estimate was generated in block 410, the computing system 120 may not generate the second emissions estimate.

As another example, a user may be able to select whether or not to generate the second emissions estimate. The computing system 120 may thus determine whether to generate the second emissions estimate based on the user selection. In still other examples, the computing system 120 may be configured to generate the second emissions estimate by default, regardless of whether the first emissions estimate was determined in block 410.

In some examples, the computing system 120 can execute the measurement sufficiency determination module 218 to determine whether there is a sufficient number of measurements or samples associated with the selected type of equipment. If so, the computing system 120 can determine that a second emissions estimate is to be generated. Otherwise, the computing system 120 can determine that a second emissions estimate is not to be generated.

In block 416, the computing system 120 generates the second emissions estimate for the selected type of equipment. For example, the computing system 120 can execute the second emissions estimation module 214 to generate the second emissions estimate.

In block 418, the computing system 120 determines if there are more types of equipment to be analyzed. If so, the process can return to block 408 where another type of equipment can be selected. If not, the process can proceed to block 420.

In block 420, the computing system 120 generates emissions information associated with a target site based on the first emissions estimate, the second emissions estimate, or both of these associated with each type of equipment. In some examples, the computing system 120 can determine the emissions information by executing the GUI generation module 206.

As one particular example, the computing system 120 can receive a user input indicating a set of equipment at the target site. The computing system 120 may also receive a user input indicating a timespan to be analyzed. The computing system 120 can then determine one or more total emissions estimates over the selected timespan for a particular type of equipment input by the user. For instance, the computing system 120 can determine a first total emissions estimate for the particular type of equipment based on the first emissions estimate and the selected timespan. The computing system 120 can also determine a second total emissions estimate for the particular type of equipment based on the second emissions estimate and the selected timespan. This computing system 120 may repeat this process for each type of equipment input by the user.

In block 422, the computing system 120 generates a graphical user interface providing the emissions information to a user 266. For example, the graphical user interface can include the one or more total emissions estimates for each type of equipment at the target site. In some examples, the computing system 120 can execute the GUI generation module 206 to generate the graphical user interface.

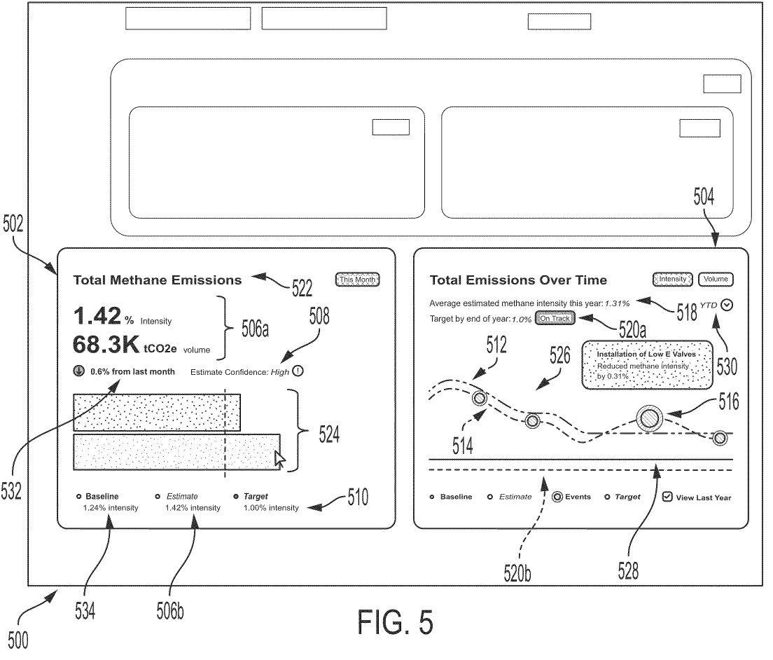

FIGS. 5-7 depict examples of a graphical user interface 500 according to some aspects of the present disclosure. Although these figures depict a certain number and combination of visual elements, this is for illustrative purposes and intended to be non-limiting. In other examples, the graphical user interface 500 can include more visual elements, fewer visual elements, different visual elements, or a different arrangement of the visual elements shown in FIGS. 5-7.

Referring now to FIG. 5, the graphical user interface 500 can be presented to the user via the user device 228. The site-level estimates box 502 can describe the aggregate emissions of all the equipment at a target site estimated for a particular gaseous byproduct 522. In some examples, the aggregate emissions may be determined based on first emissions estimates, generated using the first emissions estimation module 212, for the equipment. The aggregate emissions are provided in a selectable unit 506a. The site-level estimates box 502 can also include a change value 532 indicating how the estimates have changed over a period of time. In this example, the site-level estimates box 502 also indicates a qualitative measure of the statistical confidence 508 in the displayed estimate, according to some aspects of the present disclosure. The site-level estimates box 502 can also include a graphical portrayal 524, such as a bar graph, of the estimated site-level emissions. The graphic portrayal 524 can specify the estimated emissions 506 as well as emissions reduction targets 510 and baseline emissions measurements 534. In some examples, the baseline emissions measurements may be determined based on second emissions estimates, generated using the second emissions estimation module 214, for the equipment.

The graphical user interface 500 also includes a site-level historical measurements box 504, which summarizes site-level emissions data over a specified time period 530. The site-level historical measurements box 504 displays an aggregated statistical summary 518, for example the average emissions, of the estimated site-level emissions for the selected time period 530. The site-level historical measurements box 504 also displays a target emissions reduction value 520a at the end of the specified time period 530. Other information can also be included in the site-level historical measurements box 504. For example, the site-level historical measurements box 504 can display a graphical portrayal 526, such as a line graph, of one or more aggregate estimated gaseous byproduct emissions of all the equipment at a target site for a particular gaseous byproduct 522. The graphical portrayal 526 can indicate the estimated emissions 514 and baseline emissions 528 relative to emissions reductions targets 520b. The graphical portrayal 526 can also include historical event data 516 highlighting events that might affect the emissions estimates. The graphical portrayal 526 can also display historical data from previous time periods 512.

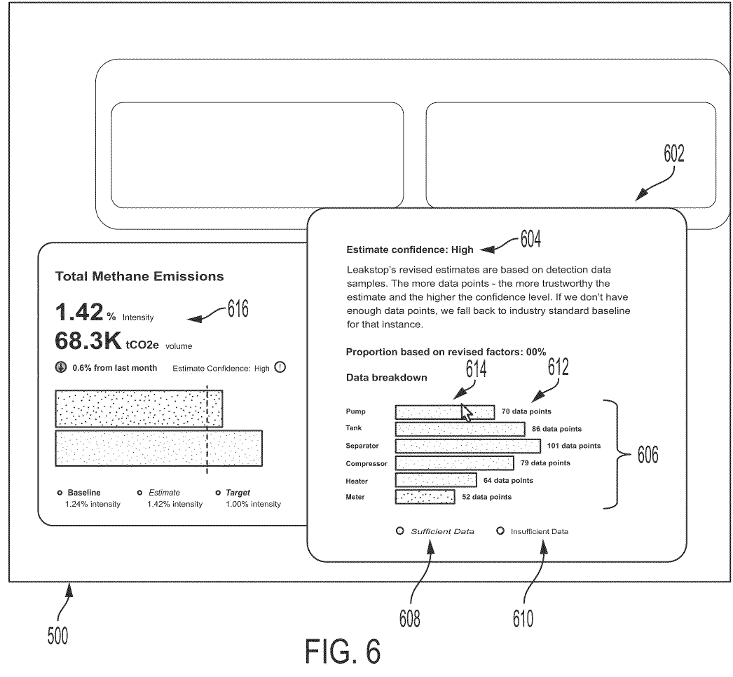

FIG. 6 depicts another view of the graphical user interface 500 according to some aspects of the present disclosure. The statistical confidence drill-down box 602 may be revealed upon a user selecting a selectable object in the graphical user interface 500, such as the site-level estimates box 502. As shown, the statistical confidence drill-down box 602 describes the factors contributing to the qualitative measure of the statistical confidence in the estimated emissions 604. The statistical confidence drill-down box 602 can display, for example, the number of measurements assigned to each piece of equipment used to calculate the aggregate emissions estimate 616. The data display 606 can include both numerical data 612 as well as a graphical portrayal 614 of that data, for example, a bar graph. The data display 606 can indicate if sufficient data 608 was available to make an emissions estimate for a particular type of equipment. The data display 606 can also indicate if insufficient data 610 was available to make an emissions estimate for a particular type of equipment.

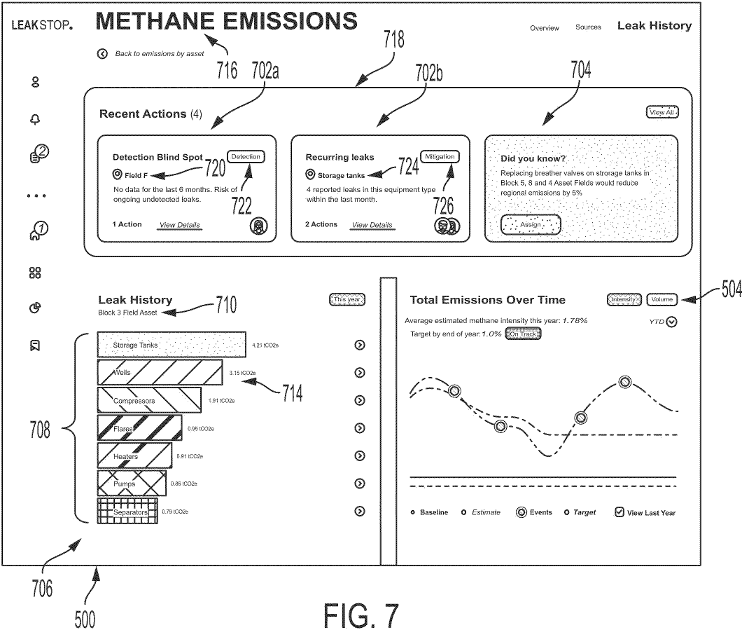

FIG. 7 depicts another view of the graphical user interface 500 according to some aspects of the present disclosure. The equipment-level estimates summary box 706 shows the estimated gaseous byproduct emissions for various types of equipment at a target site 710 for a particular byproduct 716. The equipment-level estimates summary box 706 can display estimated emissions for various types of equipment at the target site using numerical values 714 or graphically 708, for example, as a bar graph.

The recent actions box 718 can display one or more events that might affect emissions estimates. In one example event 702a, a detection event 722 is displayed that affects the estimates associated with a particular site 720. In another example event 702b, a mitigation event 726 is displayed which affects the estimates associated with a type of equipment 724. The recent actions box 718 can also display recommendations 704 that might help reduce emissions at a particular site or for a particular type of equipment.

In some aspects, graphical user interfaces for abating emissions of gaseous byproducts from hydrocarbon assets can be implemented according to one or more of the following examples. As used below, any reference to a series of examples is to be understood as reference to each of those examples disjunctively (e.g., “Examples 1-4” is to be understood as “Examples 1, 2, 3, or 4”).

Example #1: A system comprising a processor and a memory including instructions that are executable by the processor for causing the processor to: receive a plurality of measurements of gaseous byproduct emissions collected from one or more sites; execute a classification module to determine how to distribute the plurality of measurements among a plurality of types of equipment, the classification module being configured to assign each measurement of the plurality of measurements to a corresponding type of equipment among the plurality of types of equipment, to thereby generate a dataset that includes assignments of the plurality of measurements to the plurality of types of equipment; execute an emissions estimation module based on the dataset to determine a plurality of emissions estimates associated with the plurality of types of equipment, each emissions estimate corresponding to a respective type of equipment among the plurality of types of equipment and being determined based on a respective subset of measurements assigned to the respective type of equipment in the dataset; receive a user input that includes a list of types of equipment at a target site; generate a total emissions estimate for each type of equipment in the list based on the plurality of emissions estimates; and generate a graphical user interface providing the total emissions estimate for each type of equipment in the list to a user.

Example #2: The system of Example #1, wherein the memory includes instructions that are further executable by the processor to receive the plurality of measurements of gaseous byproduct emissions from a plurality of data sources associated with the one or more sites.

Example #3: The system of Example #2, wherein the plurality of data sources include a satellite configured to monitor the one or more sites, a drone configured to monitor the one or more sites, and a group of sensors coupled to the plurality of types of equipment at the one or more sites.

Example #4: The system of any of Examples #2-3, wherein the memory further includes a data preprocessing module that is executable to generate the plurality of measurements by: normalizing a set of measurements from the plurality of data sources; and removing one or more outliers from the set of measurements.

Example #5: The system of any of Examples #1-4, wherein the memory includes instructions that are further executable by the processor to: receive, as input from the user, a respective quantity of each type of equipment in the list; and generate the total emissions estimate for each type of equipment in the list by multiply (i) the respective quantity of the type of equipment by (ii) an emissions estimate corresponding to the type of equipment from among the plurality of emissions estimates.

Example #6: The system of any of Examples #1-5, wherein the emissions estimation module is a first emissions estimation module and the plurality of emissions estimates are a plurality of first emissions estimates, and wherein the memory further includes a second emissions estimation module that is executable by the processor to: determine a plurality of second emissions estimates corresponding to the plurality of types of equipment, each emissions estimate in the plurality of second emissions estimates being a predefined value in a lookup table corresponding to a particular type of equipment among the plurality of types of equipment, wherein the plurality of second emissions estimates are different from the plurality of first emissions estimates.

Example #7: The system of Example #6, wherein the memory includes instructions that are further executable by the processor to: determine a first emissions estimate corresponding to a specific type of equipment from among the plurality of first emissions estimates; determine a first accuracy metric for the first emissions estimate; determine a second emissions estimate corresponding to the specific type of equipment from among the plurality of second emissions estimates; determine a second accuracy metric for the second emissions estimate; compare the first accuracy to the second accuracy to determine a most accurate estimate among the first emissions estimate and the second emissions estimate; and based on determining that the first emissions estimate is the most accurate estimate, determine the total emissions estimate for the particular type of equipment based on the first emissions estimate and not the second emissions estimate.

Example #8: The system of any of Examples #1-7, wherein the emissions estimation module is further is executable to determine the plurality of emissions estimates by, for each respective type of equipment in the plurality of types of equipment: determining a statistical mean of the respective subset of measurements assigned to the respective type of equipment; and storing the statistical mean as an emissions estimate for the respective type of equipment.

Example #9: A method comprising receiving, by a computing system. a plurality of measurements of gaseous byproduct emissions collected from one or more sites; executing, by the computing system, a classification module to determine how to distribute the plurality of measurements among a plurality of types of equipment, the classification module being configured to assign each measurement of the plurality of measurements to a corresponding type of equipment among the plurality of types of equipment, to thereby generate a dataset that includes assignments of the plurality of measurements to the plurality of types of equipment; executing, by the computing system, an emissions estimation module based on the dataset to determine a plurality of emissions estimates associated with the plurality of types of equipment, each emissions estimate corresponding to a respective type of equipment among the plurality of types of equipment and being determined based on a respective subset of measurements assigned to the respective type of equipment in the dataset; receiving, by the computing system, a user input that includes a list of types of equipment at a target site; generating, by the computing system, a total emissions estimate for each type of equipment in the list based on the plurality of emissions estimates; and generating, by the computing system, a graphical user interface providing the total emissions estimate for each type of equipment in the list to a user.

Example #10: The method of Example #9, wherein the plurality of measurements of gaseous byproduct emissions are collected from a plurality of data sources.

Example #11: The method of Example #10, wherein the plurality of data sources include a satellite configured to monitor the one or more sites, a drone configured to monitor the one or more sites, and a group of sensors coupled to the plurality of types of equipment at the one or more sites.

Example #12: The method of any of Examples #10-11, further comprising generating the plurality of measurements by: normalizing a set of measurements from the plurality of data sources; and removing one or more outliers from the set of measurements.

Example #13: The method of any of Examples #9-12, further comprising receiving, as input from the user, a respective quantity of each type of equipment in the list; and generating the total emissions estimate for each type of equipment in the list by multiply (i) the respective quantity of the type of equipment by (ii) an emissions estimate corresponding to the type of equipment from among the plurality of emissions estimates.

Example #14: The method of any of Examples #9-13, wherein the emissions estimation module is a first emissions estimation module and the plurality of emissions estimates are a plurality of first emissions estimates, and further comprising: determining a plurality of second emissions estimates corresponding to the plurality of types of equipment, each emissions estimate in the plurality of second emissions estimates being a predefined value in a lookup table corresponding to a particular type of equipment among the plurality of types of equipment, wherein the plurality of second emissions estimates are different from the plurality of first emissions estimates.

Example #15: The method of any of Examples #9-14, further comprising determining a first emissions estimate corresponding to a specific type of equipment from among the plurality of first emissions estimates; determining a first accuracy metric for the first emissions estimate; determining a second emissions estimate corresponding to the specific type of equipment from among the plurality of second emissions estimates; determining a second accuracy metric for the second emissions estimate; comparing the first accuracy to the second accuracy to determine a most accurate estimate among the first emissions estimate and the second emissions estimate; and based on determining that the first emissions estimate is the most accurate estimate, determining the total emissions estimate for the particular type of equipment based on the first emissions estimate and not the second emissions estimate.

Example #16: The method of any of Examples #9-15, further comprising determining the plurality of emissions estimates by, for each respective type of equipment in the plurality of types of equipment: determining a statistical mean of the respective subset of measurements assigned to the respective type of equipment; and storing the statistical mean as an emissions estimate for the respective type of equipment.

Example #17: A non-transitory computer-readable medium comprising program code that is executable by a processor for causing the processor to: receive a plurality of measurements of gaseous byproduct emissions collected from one or more sites; execute a classification module to determine how to distribute the plurality of measurements among a plurality of types of equipment, the classification module being configured to assign each measurement of the plurality of measurements to a corresponding type of equipment among the plurality of types of equipment, to thereby generate a dataset that includes assignments of the plurality of measurements to the plurality of types of equipment; execute an emissions estimation module based on the dataset to determine a plurality of emissions estimates associated with the plurality of types of equipment, each emissions estimate corresponding to a respective type of equipment among the plurality of types of equipment and being determined based on a respective subset of measurements assigned to the respective type of equipment in the dataset; receive a user input that includes a list of types of equipment at a target site; generate a total emissions estimate for each type of equipment in the list based on the plurality of emissions estimates; and generate a graphical user interface providing the total emissions estimate for each type of equipment in the list to a user.

Example #18: The non-transitory computer-readable medium of Example #17, further comprising program code that is executable by the processor for causing the processor to: receive, as input from the user, a respective quantity of each type of equipment in the list; and generate the total emissions estimate for each type of equipment in the list by multiply (i) the respective quantity of the type of equipment by (ii) an emissions estimate corresponding to the type of equipment from among the plurality of emissions estimates.

Example #19: The non-transitory computer-readable medium of any of Examples #17-18, wherein the emissions estimation module is a first emissions estimation module and the plurality of emissions estimates are a plurality of first emissions estimates, and further comprising program code that is executable by the processor to: determine a plurality of second emissions estimates corresponding to the plurality of types of equipment, each emissions estimate in the plurality of second emissions estimates being a predefined value in a lookup table corresponding to a particular type of equipment among the plurality of types of equipment, wherein the plurality of second emissions estimates are different from the plurality of first emissions estimates.

Example #20: The non-transitory computer-readable medium of any of Examples #17-19, further comprising program code that is executable by the processor for causing the processor to determine the plurality of emissions estimates by, for each respective type of equipment in the plurality of types of equipment: determining a statistical mean of the respective subset of measurements assigned to the respective type of equipment; and storing the statistical mean as an emissions estimate for the respective type of equipment.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A system comprising:
a processor; and
a memory including instructions that are executable by the processor for causing the processor to:
receive a plurality of measurements of gaseous byproduct emissions collected from one or more sites;
execute a classification module to determine how to distribute the plurality of measurements among a plurality of types of equipment, the classification module being configured to assign each measurement of the plurality of measurements to a corresponding type of equipment among the plurality of types of equipment, to thereby generate a dataset that includes assignments of the plurality of measurements to the plurality of types of equipment;
execute an emissions estimation module based on the dataset to determine a plurality of emissions estimates associated with the plurality of types of equipment, each emissions estimate corresponding to a respective type of equipment among the plurality of types of equipment and being determined based on a respective subset of measurements assigned to the respective type of equipment in the dataset;
receive a user input that includes a list of types of equipment at a target site;
generate a total emissions estimate for each type of equipment in the list based on the plurality of emissions estimates; and
generate a graphical user interface providing the total emissions estimate for each type of equipment in the list to a user.

2. The system of claim 1, wherein the memory includes instructions that are further executable by the processor to receive the plurality of measurements of gaseous byproduct emissions from a plurality of data sources associated with the one or more sites.

3. The system of claim 2, wherein the plurality of data sources include a satellite configured to monitor the one or more sites, a drone configured to monitor the one or more sites, and a group of sensors coupled to the plurality of types of equipment at the one or more sites.

4. The system of claim 2, wherein the memory further includes a data preprocessing module that is executable to generate the plurality of measurements by:
normalizing a set of measurements from the plurality of data sources; and
removing one or more outliers from the set of measurements.

5. The system of claim 1, wherein the memory includes instructions that are further executable by the processor to:
receive, as input from the user, a respective quantity of each type of equipment in the list; and
generate the total emissions estimate for each type of equipment in the list by multiply (i) the respective quantity of the type of equipment by (ii) an emissions estimate corresponding to the type of equipment from among the plurality of emissions estimates.

6. The system of claim 1, wherein the emissions estimation module is a first emissions estimation module and the plurality of emissions estimates are a plurality of first emissions estimates, and wherein the memory further includes a second emissions estimation module that is executable by the processor to:
determine a plurality of second emissions estimates corresponding to the plurality of types of equipment, each emissions estimate in the plurality of second emissions estimates being a predefined value in a lookup table corresponding to a particular type of equipment among the plurality of types of equipment, wherein the plurality of second emissions estimates are different from the plurality of first emissions estimates.

7. The system of claim 6, wherein the memory includes instructions that are further executable by the processor to:
determine a first emissions estimate corresponding to a specific type of equipment from among the plurality of first emissions estimates;
determine a first accuracy metric for the first emissions estimate;
determine a second emissions estimate corresponding to the specific type of equipment from among the plurality of second emissions estimates;
determine a second accuracy metric for the second emissions estimate;
compare the first accuracy to the second accuracy to determine a most accurate estimate among the first emissions estimate and the second emissions estimate; and
based on determining that the first emissions estimate is the most accurate estimate, determine the total emissions estimate for the particular type of equipment based on the first emissions estimate and not the second emissions estimate.

8. The system of claim 1, wherein the emissions estimation module is further is executable to determine the plurality of emissions estimates by, for each respective type of equipment in the plurality of types of equipment:
determining a statistical mean of the respective subset of measurements assigned to the respective type of equipment; and
storing the statistical mean as an emissions estimate for the respective type of equipment.

9. A method comprising:
receiving, by a computing system, a plurality of measurements of gaseous byproduct emissions collected from one or more sites;
executing, by the computing system, a classification module to determine how to distribute the plurality of measurements among a plurality of types of equipment, the classification module being configured to assign each measurement of the plurality of measurements to a corresponding type of equipment among the plurality of types of equipment, to thereby generate a dataset that includes assignments of the plurality of measurements to the plurality of types of equipment;
executing, by the computing system, an emissions estimation module based on the dataset to determine a plurality of emissions estimates associated with the plurality of types of equipment, each emissions estimate corresponding to a respective type of equipment among the plurality of types of equipment and being determined based on a respective subset of measurements assigned to the respective type of equipment in the dataset;
receiving, by the computing system, a user input that includes a list of types of equipment at a target site;
generating, by the computing system, a total emissions estimate for each type of equipment in the list based on the plurality of emissions estimates; and
generating, by the computing system, a graphical user interface providing the total emissions estimate for each type of equipment in the list to a user.

10. The method of claim 9, wherein the plurality of measurements of gaseous byproduct emissions are collected from a plurality of data sources.

11. The method of claim 10, wherein the plurality of data sources include a satellite configured to monitor the one or more sites, a drone configured to monitor the one or more sites, and a group of sensors coupled to the plurality of types of equipment at the one or more sites.

12. The method of claim 10, further comprising generating the plurality of measurements by:
normalizing a set of measurements from the plurality of data sources; and
removing one or more outliers from the set of measurements.

13. The method of claim 9, further comprising:
receiving, as input from the user, a respective quantity of each type of equipment in the list; and
generating the total emissions estimate for each type of equipment in the list by multiply (i) the respective quantity of the type of equipment by (ii) an emissions estimate corresponding to the type of equipment from among the plurality of emissions estimates.

14. The method of claim 9, wherein the emissions estimation module is a first emissions estimation module and the plurality of emissions estimates are a plurality of first emissions estimates, and further comprising:
determining a plurality of second emissions estimates corresponding to the plurality of types of equipment, each emissions estimate in the plurality of second emissions estimates being a predefined value in a lookup table corresponding to a particular type of equipment among the plurality of types of equipment, wherein the plurality of second emissions estimates are different from the plurality of first emissions estimates.

15. The method of claim 14, further comprising:
determining a first emissions estimate corresponding to a specific type of equipment from among the plurality of first emissions estimates;
determining a first accuracy metric for the first emissions estimate;
determining a second emissions estimate corresponding to the specific type of equipment from among the plurality of second emissions estimates;
determining a second accuracy metric for the second emissions estimate;
comparing the first accuracy to the second accuracy to determine a most accurate estimate among the first emissions estimate and the second emissions estimate; and
based on determining that the first emissions estimate is the most accurate estimate, determining the total emissions estimate for the particular type of equipment based on the first emissions estimate and not the second emissions estimate.

16. The method of claim 14, further comprising determining the plurality of emissions estimates by, for each respective type of equipment in the plurality of types of equipment:
determining a statistical mean of the respective subset of measurements assigned to the respective type of equipment; and
storing the statistical mean as an emissions estimate for the respective type of equipment.

17. A non-transitory computer-readable medium comprising program code that is executable by a processor for causing the processor to:
receive a plurality of measurements of gaseous byproduct emissions collected from one or more sites;
execute a classification module to determine how to distribute the plurality of measurements among a plurality of types of equipment, the classification module being configured to assign each measurement of the plurality of measurements to a corresponding type of equipment among the plurality of types of equipment, to thereby generate a dataset that includes assignments of the plurality of measurements to the plurality of types of equipment;
execute an emissions estimation module based on the dataset to determine a plurality of emissions estimates associated with the plurality of types of equipment, each emissions estimate corresponding to a respective type of equipment among the plurality of types of equipment and being determined based on a respective subset of measurements assigned to the respective type of equipment in the dataset;
receive a user input that includes a list of types of equipment at a target site;
generate a total emissions estimate for each type of equipment in the list based on the plurality of emissions estimates; and
generate a graphical user interface providing the total emissions estimate for each type of equipment in the list to a user.

18. The non-transitory computer-readable medium of claim 17, further comprising program code that is executable by the processor for causing the processor to:
receive, as input from the user, a respective quantity of each type of equipment in the list; and
generate the total emissions estimate for each type of equipment in the list by multiply (i) the respective quantity of the type of equipment by (ii) an emissions estimate corresponding to the type of equipment from among the plurality of emissions estimates.

19. The non-transitory computer-readable medium of claim 17, wherein the emissions estimation module is a first emissions estimation module and the plurality of emissions estimates are a plurality of first emissions estimates, and further comprising program code that is executable by the processor to:
determine a plurality of second emissions estimates corresponding to the plurality of types of equipment, each emissions estimate in the plurality of second emissions estimates being a predefined value in a lookup table corresponding to a particular type of equipment among the plurality of types of equipment, wherein the plurality of second emissions estimates are different from the plurality of first emissions estimates.

20. The non-transitory computer-readable medium of claim 17, further comprising program code that is executable by the processor for causing the processor to determine the plurality of emissions estimates by, for each respective type of equipment in the plurality of types of equipment:
determining a statistical mean of the respective subset of measurements assigned to the respective type of equipment; and
storing the statistical mean as an emissions estimate for the respective type of equipment.
